(19) United States
(12) Patent Application Publication
(10) Pub. No.: US 2026/0188152 A1
(43) Pub. Date: Jul. 2, 2026

(54) DISPLAY DEVICE, DRIVING METHOD THEREFOR, AND DISPLAY SYSTEM

(71) Applicant: TCL CHINA STAR OPTOELECTRONICS TECHNOLOGY CO., LTD., Shenzhen (CN)

(72) Inventors: Jianshun HUANG, Shenzhen (CN); Feiyan ZOU, Shenzhen (CN)

(73) Assignee: TCL CHINA STAR OPTOELECTRONICS TECHNOLOGY CO., LTD., Shenzhen (CN)

(21) Appl. No.: 19/236,954

(22) Filed: Jun. 12, 2025

(30) Foreign Application Priority Data
Dec. 26, 2024 (CN) 202411975104.4

(51) Int. Cl. G09G 3/00; G09G 3/20

(52) U.S. Cl. CPC G09G 3/006; G09G 3/2092; G09G 2310/0267; G09G 2310/0275; G09G 2330/021; G09G 2330/12

(57) ABSTRACT

The present disclosure provides a display device, a driving method therefor, and a display system. The display device includes a display panel and a timing controller electrically connected to the display panel. The timing controller is configured to acquire a display control signal, configured to determine whether the display control signal is abnormal, and configured to output a feedback signal when the display control signal is abnormal.

### CROSS-REFERENCE TO RELATED APPLICATION

This application claims priority to Chinese Patent Application No. 202411975104.4, filed on Dec. 26, 2024. The disclosure of the aforementioned application is incorporated herein by reference in its entirety.

### TECHNICAL FIELD

The present disclosure relates to the field of display technologies, and in particular, to a display device, a driving method therefor, and a display system.

### BACKGROUND

With the development of the display industry, the application of display devices can be seen everywhere in rail transit and other scenarios, such as dynamic map displays, carriage advertising screens, high-speed rail seat screens, etc.

However, due to a relatively large number of display devices in scenarios such as rail transit, it currently takes a long time for personnel to inspect each one to confirm whether a display system is abnormal and then determine whether to repair it.

### SUMMARY

The present disclosure provides a display device. The display device includes a display panel and a timing controller electrically connected to the display panel. The timing controller is configured to acquire a display control signal, configured to determine whether the display control signal is abnormal, and configured to output a feedback signal when the display control signal is abnormal.

The present disclosure also provides a display system, including: a plurality of display devices as described in any of the above and a central control device configured to receive the feedback signal output by each of the display devices.

The present disclosure also provides a driving method for a display device, and the driving method includes: acquiring, by a timing controller, a display control signal; and determining whether the display control signal is abnormal and outputting a feedback signal when the display control signal is abnormal by the timing controller.

### BRIEF DESCRIPTION OF THE DRAWINGS

FIG. 1 is an architectural diagram of a display device according to embodiments of the present disclosure.

FIG. 2 is a block diagram of a timing controller provided by embodiments of the present disclosure.

FIG. 3 is a block diagram of a display system provided by embodiments of the present disclosure.

FIG. 4 is a flow chart of a driving method for a display device provided by embodiments of the present disclosure.

FIG. 5 and FIG. 6 are flow charts of a driving method for a display system provided by embodiments of the present disclosure.

### DETAILED DESCRIPTION

The technical proposals in the embodiments of the present disclosure will be clearly and completely described below with reference to the accompanying drawings in the embodiments of the present disclosure. Obviously, the described embodiments are only some of the embodiments of the present disclosure, but not all of the embodiments. Based on the embodiments of the present disclosure, all other embodiments obtained by those skilled in the art without making creative efforts fall within the scope of protection of the present disclosure.

In the description of the present disclosure, the terms “first”, “second”, etc. are used for descriptive purposes only and cannot be understood as indicating or implying relative importance or implicitly indicating the number of indicated technical features. Thus, features defined as “first” and “second” may explicitly or implicitly include one or more of the described features. In addition, it should be noted that the accompanying drawings only provide structures that are closely related to the present disclosure and omit some details that are not closely related to the present disclosure, which is to simplify the drawings and make the present disclosure points clear at a glance, rather than to illustrate that the actual device is exactly the same as the drawings, and is not intended to be a limitation of the actual device.

Reference herein to “embodiment” means that a particular feature, structure or characteristic described in connection with the embodiments can be included in at least one embodiment of the present disclosure. The appearances of this phrase at various places in the specification are not necessarily all referring to the same embodiment, nor are separate or alternative embodiments mutually exclusive of other embodiments. Those skilled in the art understand, both explicitly and implicitly, that the embodiments described herein may be combined with other embodiments.

The present disclosure provides a display device, which may include, but is not limited to, the following embodiments and combinations of the following embodiments.

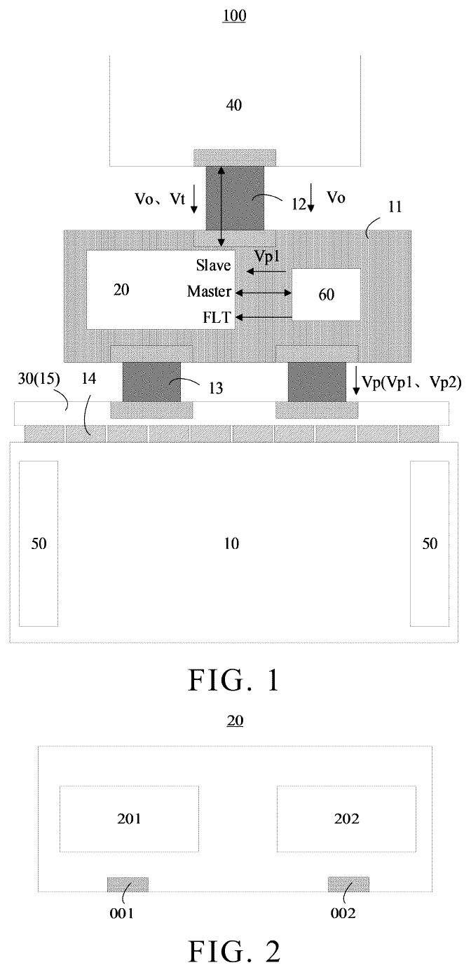

In some embodiments, as shown in FIG. 1, a display device 100 includes: a display panel 10 and a timing controller 20 electrically connected to the display panel 10. The timing controller 20 is configured to acquire a display control signal. The timing controller 20 is configured to determine whether the display control signal is abnormal, and to output a feedback signal when the display control signal is abnormal.

The display panel 10 may be, but is not limited to, an organic self-luminous display panel, an inorganic self-luminous direct display panel, or a liquid crystal display panel. The display device 100 may also include a gate driver 50 and a source driver 30. The gate driver 50 may be a gate driving circuit located on a substrate of the display panel 10 or a chip provided independently of the above display panel 10 (FIG. 1 only takes the former as an example). The source driver 30 is a chip provided independently of the above display panel 10.

Specifically, the display panel 10 may further include a plurality of gate lines electrically connected to the gate driver 50 and a plurality of data lines electrically connected to the source driver 30. The gate driver 50 generates a plurality of gate signals respectively corresponding to a plurality of rows of sub-pixels. Each gate line is electrically connected to a corresponding row of sub-pixels to transmit a corresponding gate signal to the corresponding row of sub-pixels. Each gate signal includes a gate valid pulse configured to control the corresponding row of sub-pixels to turn on. A plurality of gate valid pulses are arranged sequentially on a time axis, so that the corresponding rows of sub-pixels are turned on in sequence. Each data line is electrically connected to a corresponding column of sub-pixels to transmit thereto a corresponding data signal generated by the source driver 30. Each data signal includes a plurality of data voltages respectively corresponding to a plurality of sub-pixels in the column. The plurality of data signals respectively corresponding to a plurality of columns of sub-pixels are matched so that when each row of sub-pixels is turned on, the plurality of data voltages corresponding to the plurality of sub-pixels in the row can be output by the plurality of data lines.

The display control signal can be understood as being used to generate the gate signals and/or the data signals. Therefore, when the display control signal is abnormal, the gate signals and/or the data signals generated based on the display control signal are also abnormal. If the abnormal display control signal is not interfered with, a display image will eventually be abnormal, or the timing controller 20 will control the display panel 10 to display a fixed screen at this time. However, if the abnormal information showing the control signal is not fed back, it will take a long time to find the problem through manual inspection.

It can be understood that in the embodiments, the timing controller 20 is configured to determine whether the display control signal is abnormal, and to output a feedback signal when the display control signal is abnormal, so as to facilitate a transmission of an abnormality of the display control signal in the display device 100 to a front end, thereby shortening a detection time of the display control signal, avoiding manual detection, and reducing labor costs.

Of course, when the display control signal is normal, the timing controller 20 does not output the feedback signal, but is configured to generate signals that act on the gate driver 50 and the source driver 30 in response to the display control signal, thereby enabling the gate driver 50 to generate gate signals and/or the source driver 30 to generate data signals, so as to control the display panel 10 to display images.

Furthermore, the display control signal includes a plurality of display control sub-signals, and the feedback signal includes a plurality of feedback sub-signals each corresponding to a respective one of the plurality of the display control sub-signals. The timing controller 20 is configured to determine whether the plurality of display control sub-signals are abnormal, and to output a corresponding feedback sub-signal when one of the display control sub-signals is abnormal.

That is, in the embodiments, the display control signal is further refined to include the plurality of display control sub-signals, and the timing controller 20 can be configured to detect each display control sub-signal and determine whether each one is abnormal. The plurality of display control sub-signals are different, so when one display control sub-signal is abnormal, the timing controller 20 needs to output the feedback sub-signal corresponding to this display control sub-signal, and the feedback sub-signal needs to represent a type of and an abnormality of this display control sub-signal.

Specifically, the plurality of display control sub-signals include: a power signal Vp configured to supply power to the timing controller 20; and an image signal Vt configured for the timing controller 20 to control the display panel 10 to display an image. That is, the timing controller 20 is configured to control the display panel 10 to display an image in response to the image signal Vt. The power signal Vp is configured to supply power to the timing controller 20, and the image signal Vt is configured to control the display image of the display panel 10, so when the power signal Vp is abnormal, the timing controller 20 cannot generate correct signals to act on the gate driver 50 and the source driver 30, causing the gate signals and data signals respectively output by the gate driver 50 and the source driver 30 to be abnormal; and when the image signal Vt is abnormal, the timing controller 20 cannot generate a correct signal to act on the source driver 30, causing the data signals output by the source driver 30 to be abnormal.

It can be understood that the timing controller 20 in the embodiments can output a corresponding feedback sub-signal when an abnormality of the power signal Vp is detected, and output a corresponding feedback sub-signal when an abnormality of the image signal Vt is detected, so that the abnormality of the two signals are detected, thereby avoiding the generation of abnormal gate signals and the generation of abnormal data signals, and improving the reliability of abnormality detection of the display device 100.

In some embodiments, as shown in FIG. 1, the display device 100 further includes: a system chip 40 (which may represent the front end of the timing controller 20) electrically connected to the timing controller 20 and configured to provide the image signal Vt and an original power signal Vo to the timing controller 20. The original power signal Vo is configured to supply power to the timing controller 20. The system chip 40 may be, but is not limited to, a System on Chip (SOC). The image signal Vt can be transmitted through a Low Voltage Differential Signaling (LVDS) or a V-by-One (VBO) signal.

Specifically, the LVDS does not require encoding. The VBO signal adopts 8B or 10B encoding, which is better compatible with other high-speed serials. Converting 8 Bit data to 10 Bit data can effectively solve a direct current (DC) balance. To handle signals of 1080P 30 bit color and 240 Hz refresh frequency, the LVDS requires 48 pairs of signal lines, while the VBO signal only requires 8 pairs of signal lines, effectively reducing the costs of wires. The LVDS adopts a DC coupling, which provides a direct connected channel for the signal, so all components of the signal (including an alternating current (AC) and the DC) will be transmitted to a receiving end. The VBO signal adopts an AC coupling, which connects a capacitor in series between a signal transmitting end and the receiving end, so that the DC component of the signal is isolated, a cut-off frequency depends on a size of the coupled capacitor, and a low-frequency AC component of the signal will also be blocked and greatly attenuated, but a high-frequency AC component of the signal can still pass through well. Therefore, high-speed serial signals generally adopt an AC coupling method.

Specifically, the timing controller 20 needs to use the original power signal Vo as an operation voltage, generate control signals that act on the gate driver 50 and the source driver 30 in response to the image signal Vt and the power signal Vp, and generate image data signals that act on the source driver 30, thus the gate driver 50 generates the gate signals, and the source driver 30 generates the data signal, thereby driving the display panel 10 to display images.

In some embodiments, as shown in FIG. 1, the display device 100 further includes: a power manager 60 electrically connected to the system chip 40 and the timing controller 20. The power manager 60 is configured to acquire the original power signal Vo from the system chip 40, and is further configured to generate a first power signal Vp1 transmitted to the timing controller 20 in response to the original power signal Vo, where the power signal Vp includes the first power signal Vp1.

The power manager 60 and the timing controller 20 may be integrated on a first circuit board 11, and the system chip 40 and the first circuit board 11 can be electrically connected through a first chip-on-film (COF) 12. A second circuit board 15 configured for carrying the source driver 30 may be electrically connected to the first circuit board 11 through a second chip-on-film 13. The source driver 30 and the display panel 10 may be electrically connected through a third chip-on-film 14.

Based on the above discussion, it can be seen that both the timing controller 20 and the power manager 60 need to acquire the original power signal Vo, and the power manager 60 needs to convert the original power signal Vo to generate various power signals Vp. The operation voltage of the timing controller 20 is the original power signal Vo, but the timing controller 20 needs to generate signals for controlling the gate driver 50 and the source driver 30 based on the first power signal Vp1 and the image signal Vt.

Specifically, after the original power signal Vo supplies power to the timing controller 20, the timing controller 20 can generate an image data signal RSDS, a frame start signal STV, a frame clock signal CKV, a horizontal start signal STH, and a horizontal clock signal CKH in response to the first power signal Vp1 and the image signal Vt. A color signal of the image signal Vt is configured to generate the image data signal RSDS and output the image data signal RSDS to the source driver 30. A horizontal and field synchronization signal of the image signal Vt is configured to generate the horizontal start signal STH and the horizontal clock signal CKH and configured to output the horizontal start signal STH and the horizontal clock signal CKH to the source driver 30, so as to convert the image data signal RSDS that is serial into row-by-row parallel pixel data signals. The pixel data signals are loaded to the display panel 10 as the above data signals at least after assigned by a gamma correction voltage. The horizontal and field synchronization signal of the image signal Vt is further configured to generate the frame start signal STV and the frame clock signal CKV and configured to output the frame start signal STV and the frame clock signal CKV to the gate driver 50, so that the gate driver 50 generates the plurality of gate valid pulses shifted row by row from top to bottom that act on the display panel 10, so as to display the pixel signals row by row, where the row-by-row pixel signals are sent from the source driver 30.

Furthermore, the operation of each of the gate driver 50 and the source driver 30 also requires the power signal Vp. For example, the source driver 30 also needs to generate the data signals in response to the above-mentioned first power signal Vp1. For example, the gate driver 50 can also generate the gate signals in response to the second power signal Vp2 that is generated by the power manager 60 in response to the original power signal Vo.

In some embodiments, as shown in FIG. 2 and Table 1, the timing controller 20 includes: a first register 201, at least part of the information stored in the first register 201 is set by the timing controller 20 as first information when the image signal Vt is abnormal, and the feedback sub-signal corresponding to the image signal Vt includes the first information. The system chip 40 is configured to generate an image abnormality signal in response to the first information.

TABLE 1

| Type of display | Register | | Abnormal |
|---|---|---|---|
| control signal | address | Register value | condition |
| Image signal | A8 C0 00 91 F4 | A9 00 00 02 21 | 21: Normal |
| Vt | | A9 79 00 02 0A | OA: Abnormal |
| Power signal | A8 C0 00 9B 90 | A9 00 00 00 55 | 55: Normal |
| Vp | | A9 00 00 00 AA | AA: Vp1 is |
| | | | abnormal |
| | | A9 00 00 00 A0 | A0: Vp2 is |
| | | | abnormal |
| | | A9 00 00 00 A1 | A1: Vp1 andVp2 |
| | | | are abnormal |

It can be understood that the timing controller 20 of the embodiments sets the information stored in the first register 201 to include the first information when the image signal Vt is abnormal. When the system chip 40 reads that the information stored in the first register 201 includes the first information, the image abnormality signal can be output to indicate that a type of the display control sub-signal is the image signal Vt, and then the type of the display control sub-signal transmitting the abnormality of the display device 100 to the front end is the image signal Vt.

The communication related to the above feedback signal can be carried out through, but is not limited thereto, an I²C interface in interfaces of the timing controller 20. The I²C interface can be configured for the communication of three signals: read-write signal WP, clock signal SCL, and data signal SDA. When the read-write signal WP is at a corresponding high potential, the timing controller 20 and the system chip 40 can communicate, and when the read-write signal WP is at a responding low potential, the timing controller 20 and the system chip 40 cannot communicate.

Specifically, as shown in Table 1, the communication related to the above feedback signal may include the following steps (1) to (4).

In step (1), the system chip 40 controls the read-write signal WP to a corresponding high potential, so that the timing controller 20 and the system chip 40 can communicate.

In step (2), the system chip 40 sends an addressing signal (for example, 5-byte data “A8 C0 00 91 F4”) to perform corresponding register addressing in the timing controller 20 (for example, searching the first register 201 through an address of the first register 201).

In step (3), the timing controller 20 sends the information stored in a corresponding register to the system chip 40 (for example, sends at least part of the information stored in the first register 201).

In step (4), the system chip 40 determines whether the corresponding display control sub-signal is abnormal based on the information stored in the register (for example, it determines that the image signal is abnormal when the information stored in the first register 201 includes the first information).

It should be noted that here, the 5-byte data transmitted by the timing controller 20 and the system chip 40 is taken as an example, but it is not limited to this. Here, when the data of a first byte in the 5-byte data is “A8”, it means that the data is written by the system chip 40 to the timing controller 20, and when the data of a first byte in the 5-byte data is “A9”, it means that the data is read by the system chip 40 from the timing controller 20, but is not limited thereto. Here, it is taken as an example that the system chip 40 reads the data of 4 bytes stored in the register, and the last byte is valid data, but is not limited to this.

For example, in the above step (2), the data of the first byte of “A8 C0 00 91 F4” is “A8”, which means that the system chip 40 writes the data to the timing controller 20 (here is addressing); in the above step (3), the data sent by the timing controller 20 to the system chip 40 may include “A9 00 00 02 21” or “A9 79 00 02 0A” as the corresponding feedback sub-signal, the first byte data of both is “A9”, which indicates that the corresponding data is read by the system chip 40 from the timing controller 20 (here, at least part of the information stored in the first register 201 is read), the former one of the two data can be considered not the first information because the last byte is not “0A”, and the latter one of the two data can be considered the first information because the last byte is “0A”.

Through the above steps (1) to (4), the system chip 40 can send a corresponding abnormal signal to the front end when the display control sub-signal is abnormal (for example, when the information stored in the first register 201 includes the first information, the image abnormal signal is sent to the front end), and the system chip 40 does not communicate with the front end when the display control sub-signal is normal.

As shown in FIG. 1, a master control pin master of the timing controller 20 communicates with the power manager 60. The master control pin master can be configured to transmit the clock signal and manage the selection of a slave control pin Slave. The slave control pin Slave of the timing controller 20 communicates with the system chip 40, and a FLT pin (i.e., a second pin 002 below) of the timing controller 20 communicates with the power manager 60.

In some embodiments, as shown in FIG. 2 and Table 1, the timing controller 20 includes a second register 202. At least part of the information stored in the second register 202 is set by the timing controller 20 as second information when the power signal Vp is abnormal, and the feedback sub-signal corresponding to the power signal Vp includes the second information. The system chip 40 is configured to generate a power abnormality signal in response to the second information.

Similarly, the timing controller 20 of the embodiments sets the information stored in the second register 202 to include the second information when the power signal Vp is abnormal. When the system chip 40 reads that the information stored in the second register 202 includes the second information, the power abnormality signal can be output to indicate that a type of the display control sub-signal is the power signal Vp, and then the type of the display control sub-signal transmitting the abnormality of the display device 100 is the power signal Vp.

As shown in Table 1, the communication related to the above feedback signal may also include the above steps (1) to (4). The above step (2) is configured for the system chip 40 to send an addressing signal of the second register 202, for example, 5-byte data “A8 C0 00 9B 90”. The above step (3) is configured for the timing controller 20 to send at least part of the information stored in the second register 202 to the system chip 40, for example, output 5-byte data “A9 00 00 00 55” or “A9 00 00 00 AA”. The above step (4) is configured for the system chip 40 to determine whether the power signal Vp is abnormal based on whether the information stored in the second register 202 includes the second information. For example, the last byte of “A9 00 00 00 55” is not “AA”, so it can be considered the corresponding data is not the second information; and the last byte of “A9 00 00 00 AA” “AA”, so it can be considered that the corresponding data is the second information.

Similarly, through the above steps (1) to (4), the system chip 40 can send a corresponding abnormal signal to the front end when the display control sub-signal is abnormal (for example, the power abnormality signal is sent to the front end when the information stored in the second register 202 includes the second information), and the system chip 40 does not communicate with the front end when the display control sub-signal is normal.

Furthermore, since the power signal Vp includes the first power signal Vp1 and the second power signal Vp2, the second information may also include first sub-information corresponding to the abnormality of the first power signal Vp1 and second sub-information corresponding to the abnormality of the second power signal Vp2. That is, the information stored in the second register 202 is set to include the first sub-information when the first power signal Vp1 is abnormal, and is set to include the second sub-information when the second power signal Vp2 is abnormal. Table 1 only illustrates the first sub-information. For example, when the last byte of the second information is “A0”, the second information can be considered as the second sub-information. At this time, only when the last byte of the 4 bytes in the information stored in the register 202 and read by the system chip 40 is not “AA” or “A0”, it means that the power signal Vp is normal.

Furthermore, the second information may further include third sub-information corresponding to a situation that both the first power signal Vp1 and the second power signal Vp2 are abnormal. For example, when the last byte of the second information is “A1”, it can be considered that the second information is the third sub-information.

Correspondingly, the power abnormality signal may also include a first power abnormality sub-signal corresponding to the first sub-information, a second power abnormality sub-signal corresponding to the second sub-information, and a third power abnormality sub-signal corresponding to the third sub-information.

In some embodiments, as shown in conjunction with FIG. 1 and FIG. 2, the timing controller 20 includes pins, and potentials of the pins are outside a preset potential range when the power signal Vp is abnormal. The timing controller 20 is configured to set at least part of the information stored in the second register 202 as the second information when the potentials of the pins are outside the preset potential range. That is, the pins can be loaded with a judgment signal or used to output a judgment signal, and a potential of the judgment signal can be outside the preset potential range when the power signal Vp is abnormal. The timing controller 20 can then set the information stored in the second register 202 to include the second information for the system chip 40 to identify whether the power signal Vp is abnormal.

Based on the above discussion, it can be known that the above-mentioned pins may include a first pin 001 configured to indicate whether the first power signal Vp1 is abnormal and a second pin 002 configured to indicate whether the second power signal Vp2 is abnormal.

The abnormality of the first power signal Vp1 is generally caused by the abnormal output of the power manager 60. A detection circuit may be provided between a terminal of the power manager 60 for outputting the first power signal Vp1 and the first pin 001 of the timing controller 20. The detection circuit can control a potential of the first pin 001 to be outside the preset potential range when the first power signal Vp1 is abnormal.

The abnormality of the second power signal Vp2 is generally caused by the abnormality of the output of the power manager 60, the abnormality of an internal circuit of the gate driver 50, or the abnormality of a circuit connected to the gate driver 50 (that is in-plane wirings when the gate driver 50 is an in-plane gate driving circuit). Since any abnormality at this time will cause over-temperature, over-current, or over-voltage protection of the display device 100, relevant circuits are generally integrated inside the timing controller 20 to determine whether over-temperature, over-current, or over-voltage protection occurs, that is, whether the second power signal Vp2 is abnormal. The timing controller 20 will control the potential of the second pin 002 to be outside the preset potential range when over-temperature, over-current, or over-voltage protection occurs, so that there is no need to set up a circuit for controlling the potential of the second pin 002 outside the timing controller 20.

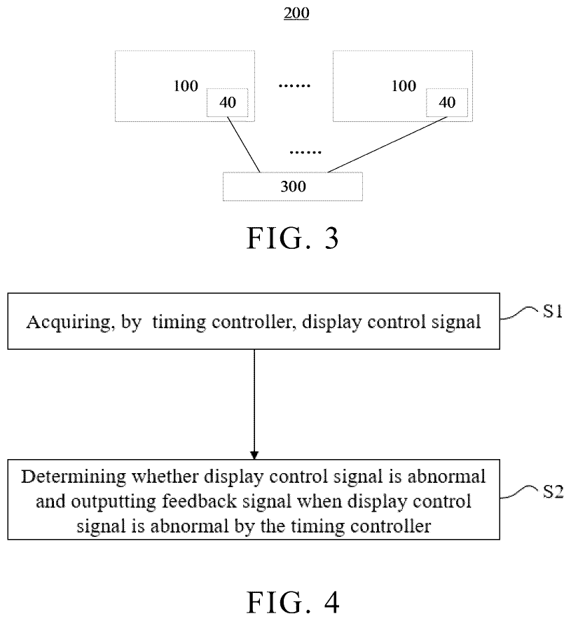

The present disclosure also provides a display system. As shown in FIG. 3, the display system 200 may include a plurality of display devices 100 as described in any of the above and a central control device 300 (which may represent the front end of a plurality of system chips 40) configured for receiving the feedback signal output by each display device 100. Specifically, the central control device 300 can be electrically connected to the system chip 40 of each display device 100. When at least one display control sub-signal is abnormal, the corresponding system chip 40 can send the corresponding abnormal signal and corresponding addressing signal to the central control device 300 (representing the corresponding display device 100).

It can be understood that the central control device 300 in the present disclosure can quickly locate the abnormal display device 100 and the type of the abnormal display control sub-signal in response to the at least one abnormal signal and the corresponding addressing signal it receives. This reduces the time required to detect a plurality of display control signals in the display system 200 and avoids manual inspection through patrol inspection, thereby reducing labor costs.

The present disclosure also provides a driving method for a display device, as shown in FIG. 4, the driving method includes, but is not limited thereto, following steps S1 and S2.

In step S1, the timing controller acquires a display control signal.

The timing controller 20 can acquire the display control signal from the system chip 40, and the display control signal is configured for the timing controller 20 to operate, and the timing controller 20 is configured to generate signals that act on the source driver 30 and the gate driver 50 accordingly, so that the source driver 30 generates data signals, and the gate driver 50 generates gate signals, thereby driving the display panel 10 to display images.

In step S2, the timing controller determines whether the display control signal is abnormal and outputs a feedback signal when the display control signal is abnormal.

It can be understood that in the embodiments, the timing controller 20 is configured to determine whether the display control signal is abnormal and output the feedback signal when the display control signal is abnormal, thereby preventing the abnormal display control signal from acting on the timing controller 20, which may cause the gate signals and/or the data signals to be abnormal. The feedback signal is transmitted to the front end to inform the front end of the abnormality of the display control signal in the display device 100, which shortens the detection time of the display control signal and avoids manual detection, thereby reducing labor costs.

In conjunction with the above discussion about the display device 100 and the display system 200, the present disclosure can also provide a driving method for the display system.

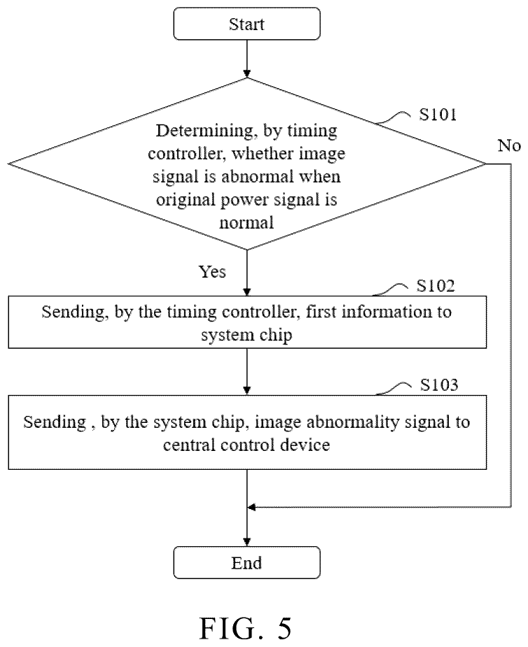

For the image signal Vt, as shown in FIG. 5, the driving method for the display system may include, but is not limited to, the following steps S101, S102, and S103 and a combination of the following steps S101, S102, and S103.

In step S101, the timing controller determines whether an image signal is abnormal when an original power signal is normal.

Based on the above discussion, it can be seen that since the timing controller 20 needs to use the original power signal Vo as the operation voltage, it is necessary to determine whether the image signal Vt is abnormal only when the original power signal Vo is normal. Otherwise, the timing controller 20 cannot work, and a corresponding signal cannot be generated regardless of whether the image signal Vt is normal or not.

When the image signal is abnormal, the steps S102 and S103 are executed.

In step S102, the timing controller sends first information to the system chip.

Based on the above discussion, it can be seen that the information stored in the first register is set by the timing controller 20 to include the first information when the image signal Vt is abnormal, so feedback sub-information sent by the timing controller 20 to the system chip 40 includes the first information.

In step S103, the system chip sends an image abnormality signal to a central control device.

Based on the above discussion, it can be seen that when the system chip 40 recognizes the first information, it can output the image abnormality signal to the central control device 300 to indicate that the abnormal display control sub-signal is the image signal Vt.

When the image signal is not abnormal, the driving method for the display system ends.

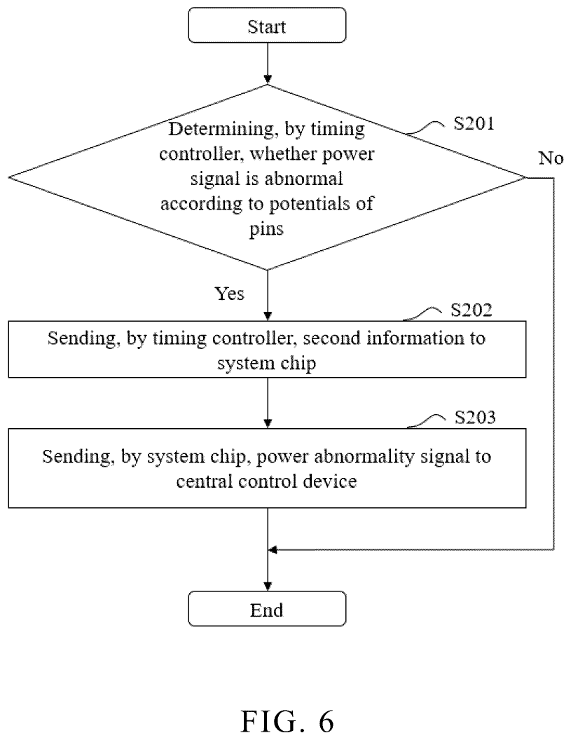

For the power signal Vp, as shown in FIG. 6, it may include, but is not limited to, the following steps S201, S202, and S203 and a combination of the following steps S201, S202, and S203.

In step S201, the timing controller determines whether a power signal is abnormal according to potentials of pins.

Based on the above discussion, it can be seen that since the potential of at least one of the first pin 001 and the second pin 002 of the timing controller 20 is outside the preset potential range when the power signal Vp is determined to be abnormal, so that the timing controller can determine whether the power signal Vp is abnormal according to the potentials of the pins.

When the power signal is abnormal, the steps S202 and S203 are executed.

In step S202, the timing controller sends second information to the system chip.

Based on the above discussion, it can be seen that the information stored in the second register is set by the timing controller 20 to include the second information (which is the first sub-information, the second sub-information, or the third sub-information) when the power signal Vp is abnormal, that is, the timing controller 20 may send corresponding sub-information to the system chip 40 as feedback sub-information according to a specific situation of the abnormality of the power signal Vp.

In step S203, the system chip sends a power abnormality signal to a central control device.

Based on the above discussion, it can be seen that when the system chip 40 recognizes the second information (any sub-information therein), it can output a power abnormality signal (corresponding power abnormality sub-signal therein) to the central control device 300 to indicate which power signal of the power signal Vp is the abnormal display control sub-signal.

When the power signal is not abnormal, the driving method for the display system ends.

The display device, the driving method therefor, and the display system provided by the embodiments of the present disclosure have been introduced in detail. This paper uses specific examples to illustrate the principles and implementation methods of the present disclosure. The description of the above embodiments is only to help understand technical proposals and core ideas of the present disclosure. Those of ordinary skill in the art should understand that they can still modify the technical proposals recorded in the foregoing embodiments, or make equivalent substitutions for some of the technical features; and these modifications or substitutions do not make the essence of the corresponding technical proposals deviate from the scope of the technical proposals of embodiments in the present disclosure.

What is claimed is:

1. A display device, comprising:
a display panel; and
a timing controller electrically connected to the display panel and configured to acquire a display control signal,
wherein the timing controller is configured to determine whether the display control signal is abnormal, and is configured to output a feedback signal when the display control signal is abnormal.

2. The display device according to claim 1, wherein the display control signal comprises a plurality of display control sub-signals, the feedback signal comprises a plurality of feedback sub-signals each corresponding to a respective one of the plurality of display control sub-signals; and
the timing controller is configured to determine whether the plurality of display control sub-signals are abnormal, and is configured to output a corresponding one of the plurality of feedback sub-signals when one of the plurality of display control sub-signals is abnormal.

3. The display device according to claim 2, wherein the plurality of display control sub-signals comprise:
a power signal configured to supply power to the timing controller; and
an image signal configured for the timing controller to control the display panel to display an image.

4. The display device according to claim 3, further comprising:
a system chip electrically connected to the timing controller, and configured to provide the image signal and an original power signal to the timing controller, wherein the original power signal is configured to supply power to the timing controller.

5. The display device according to claim 4, wherein the timing controller comprises:
a first register, wherein at least part of information stored in the first register is set by the timing controller as a first information when the image signal is abnormal, and one of the plurality of feedback sub-signals corresponding to the image signal comprises the first information; and
wherein the system chip is configured to generate an image abnormality signal in response to the first information.

6. The display device according to claim 4, further comprising:
a power manager electrically connected to the system chip and the timing controller, wherein the power manager is configured to acquire the original power signal from the system chip, and is further configured to generate a first power signal transmitted to the timing controller in response to the original power signal, and the power signal comprises the first power signal.

7. The display device according to claim 6, further comprising:
a gate driver electrically connected to the power manager and a plurality of sub-pixels of the display panel, and configured to generate gate signals that act on the plurality of sub-pixels in response to a second power signal,
wherein the power manager is further configured to generate the second power signal transmitted to the gate driver in response to the original power signal, and the power signal comprises the second power signal.

8. The display device according to claim 7, wherein the timing controller comprises:
a second register, wherein at least part of information stored in the second register is set by the timing controller as a second information when the power signal is abnormal, and one of the plurality of feedback sub-signals corresponding to the power signal comprises the second information; and
wherein the system chip is configured to generate a power abnormality signal in response to the second information.

9. The display device according to claim 8, further comprising:
a source driver electrically connected to the power manager and the plurality of sub-pixels of the display panel, and configured to generate data signals that act on the plurality of sub-pixels in response to the first power signal.

10. The display device according to claim 9, wherein the second information comprises a first sub-information corresponding to an abnormality of the first power signal, a second sub-information corresponding to an abnormality of the second power signal, and a third sub-information corresponding to a situation that both the first power signal and the second power signal are abnormal.

11. The display device according to claim 6, wherein the timing controller comprises:
a second register, wherein at least part of information stored in the second register is set by the timing controller as a second information when the power signal is abnormal, and one of the plurality of feedback sub-signals corresponding to the power signal comprises the second information; and
wherein the system chip is configured to generate a power abnormality signal in response to the second information.

12. The display device according to claim 11, wherein the timing controller comprises:
pins, wherein potentials of the pins are outside a preset potential range when the power signal is abnormal; and
wherein the timing controller is configured to set the at least part of the information stored in the second register as the second information when the potentials of the pins are outside the preset potential range.

13. The display device according to claim 6, wherein the power manager and the timing controller are integrated on a circuit board, and the system chip and the first circuit board are electrically connected through a first chip-on-film.

14. A display system, comprising:
a plurality of display devices according to claim 1; and
a central control device configured for receiving the feedback signal output by each of the plurality of display devices.

15. A driving method for a display device, comprising:
acquiring, by a timing controller, a display control signal; and
determining whether the display control signal is abnormal and outputting a feedback signal when the display control signal is abnormal by the timing controller.
